(19) United States
(12) Patent Application Publication
(10) Pub. No.: US 2017/0215378 A1
(43) Pub. Date: Aug. 3, 2017

(54) ANIMAL DRYING ATTACHMENT

(71) Applicant: John Butel, Paola, KS (US)

(72) Inventor: John Butel, Paola, KS (US)

(21) Appl. No.: 15/008,786

(22) Filed: Jan. 28, 2016

(51) Int. Cl. A01K 13/00; A46B 11/06; A46B 9/02

(52) U.S. Cl. CPC A01K 13/001; A46B 9/023; A46B 11/06; A46B 2200/1093; A46B 2200/104

(57) ABSTRACT

A dryer attachment for use to dry an animal comprising: an attachment end, where the attachment connects to a dryer; a vent opening, where the vent opening enables flow of air from the dryer; a plurality of top bristles arranged above the vent opening; and a plurality of bottom bristles arranged below the vent opening. The plurality of top bristles and plurality of bottom bristles may be arranged in a series of rows.

### BACKGROUND OF THE INVENTION

Field of Invention

The present invention relates to an attachment that is used to dry animal fur after washing.

Description of Related Art

Many pet owners must groom and maintain their animals for hygiene purposes. Some pet owners simply take their pets to a veterinarian or pet grooming facility. Other pet owners may wash and groom their pets at home. One requirement that's associated with pet grooming is the drying of the fur after a bath. Some owners use towels to dry pets however sometimes this is not effective and cold conditions can be harmful to the animal. Another common method of drying pet fur is to use blow dryers however the blow dryers typically are designed for use on a human and therefore the heat is not spread over a wide area, therefore making the process time-consuming. In order to address this problem, it would be advantageous to use attachments and other devices that may be used to speed and easily facilitate the drying of pet fur and hair.

### SUMMARY OF THE INVENTION

The present invention relates to a dryer attachment for use to dry an animal comprising: an attachment end, where the attachment connects to a dryer; a vent opening, where the vent opening enables flow of air from the dryer; a plurality of top bristles arranged above the vent opening; and a plurality of bottom bristles arranged below the vent opening. The plurality of top bristles and plurality of bottom bristles may be arranged in a series of rows. Preferably, the series of rows include three rows above the vent opening and three rows below the vent opening.

### BRIEF DESCRIPTION OF DRAWINGS

FIG. 1 depicts a front view of a drying attachment in accordance with the present invention.

### DETAILED DESCRIPTION

The present invention relates to a drying attachment that is used to facilitate the drying of animal fur in particular animal fur of dogs, cats and other pets. The drying attachment according to present invention attaches to a dryer and slips on to a hose to allow the transfer of heat through the attachment. The heat transfers through the attachment through a vent opening provided on the drying attachment. Preferably, the vent opening is in a slit form and extends the length of the attachment. Along the side of the vent opening is a plurality of bristles that allows the pet owner to brush and comb an animal's fur while heated air is directed through the vent opening to effectively dry and groom the pet with one device.

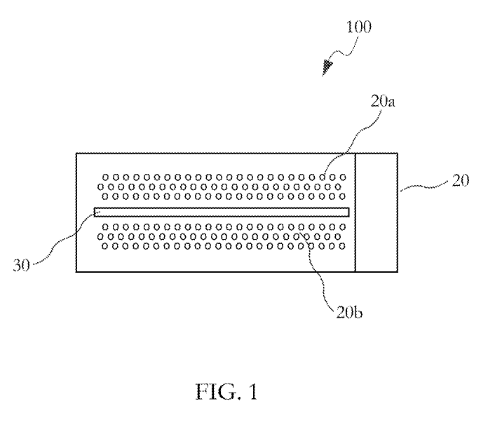

In reference to FIG. 1, an animal drying attachment 100 in accordance with the present invention is depicted. The animal drying attachment 100 includes an attachment end 20 that attaches on to and receives a hose. Once attached to the dryer air travels through the attachment 100 and exits out of a vent opening 30 shown in FIG. 1. Above the vent opening 30 is a first set of bristles running parallel to the vent opening 30. Below the vent opening 30 is a second grouping of bristles extending the entire length of the vent opening 30. Top bristles 20a preferably are aligned in a series of rows. As shown in FIG. 1, three rows of bristles for top bristles 20a are depicted. The bottom bristles 20b are also aligned in three rows and in a uniform order along the length of the attachment 100. During use, a user simply attaches the attachment 100 to the dryer hose and then initiates the dispensing of heated air through vent opening 30. The user may brush the animal fur or hair to effectively and quickly dry a wet animal. The dryer attachment 100 may be used on various types of pets such as dogs, cats or even larger animals for drying purposes. The instant invention has been shown and described in what it considers to be the most practical and preferred embodiments. It is recognized, however, that departures may be made there from within the scope of the invention and that obvious modifications will occur to a person skilled in the art.

What is claimed is:

1. A dryer attachment for use to dry an animal comprising:
a. an attachment end, where the attachment connects to a dryer;
b. a vent opening, where the vent opening enables flow of air from the dryer;
c. a plurality of top bristles arranged above the vent opening; and
d. a plurality of bottom bristles arranged below the vent opening

2. The dryer attachment according to claim 1, where the plurality of top bristles is arranged in a series of rows.

3. The dryer attachment according to claim 2, where the series of rows include three rows.

4. The dryer attachment according to claim 1, where the plurality of bottom bristles is arranged in a series of rows.

5. The dryer attachment according to claim 4, where the series of rows include three rows.
